(19) United States
(12) Patent Application Publication
(10) Pub. No.: US 2003/0188020 A1
(43) Pub. Date: Oct. 2, 2003

(54) Tangible artifact referencing digital content

(76) Inventor: Steven Barile, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/112,211

(22) Filed: Mar. 29, 2002

(51) Int. Cl. G06F 15/16

(52) U.S. Cl. 709/245

(57) ABSTRACT

Associating supplementary data with digital content that embodies a work product, wherein the supplementary data, when accessed by a production device, enables the production device to produce a tangible artifact in accordance with the supplementary data, and the tangible artifact incorporates a machine readable reference that is related to the work product.

### FIELD OF THE INVENTION

This invention relates generally to the field of work products embodied as digital content and more specifically to tangible artifacts that are associated with such digital content.

### BACKGROUND OF THE INVENTION

The recent availability of music, video and other content from sources exclusively online has meant that a consumer of such content can access and use the content without needing to handle a tangible artifact that embodies the content. Thus, for example, a user may download content such as music from the Internet and play it on a suitable computer system without handling any tangible object that contains or represents the content. Instead, the content is transported to the user from a server over a network and does not need a tangible medium for its delivery. Examples of such content include a music video provided as a Windows™ Media formatted data stream, or a recording of a concert in the form of an Motion Pictures Experts Group (MPEG) Layer-3 (MP3) audio file (ISO/IEC IS-11172-3, ISO/IEC IS-13818-3). This is in contrast to a consumer using a videotape or DVD-Video disc to play the music video, or a Compact Disc (CD), cassette tape or long-playing vinyl record (LP) to play the concert recording. Such a consumer, of necessity, handles a tangible artifact—a physical object that embodies the work product, and as such, this is the artifact that is manufactured, marketed, and sold in order to distribute the work product to the consumer.

While the ease of use and flexibility afforded by the provision of work products as online or streaming digital content is well recognized, the absence of a tangible, physical artifact representing such work products has certain disadvantages. Elements of convenience that were collaterally available with tangible artifacts are missing from exclusively online content.

First, actual access is prevented where the consumer has no device capable of Internet access. Even if the consumer has Internet access, the ease of actual access to the content is diminished, especially when the consumer is working in an environment where it is difficult to use a visual interface or input devices. Accessing online music typically requires the consumer to use a display and at least a pointing device such as a mouse if not a keyboard as well. In contrast, a CD may be played by simply slipping the disc into the receptacle of an in-dash player in an automobile that is designed to start play as soon as it detects a disc—an act that the operator of the vehicle can do with a minimum of distraction and without needing to take her attention off the road. Similarly, a disc jockey in a nightclub may load a music cassette into his player in a low-light environment by tactile sense alone and play it.

Second, having a tangible, tactile artifact representing audio or video content has other tangential, if still significant, advantages. These include the aesthetic—tangible artifacts such as record jackets or CD covers provide a space for art, graphics or logos associated with the music that are valuable to consumers in their own right and can be enjoyed independently of the content or its playback. An LP or CD jacket may be hung on a wall, displayed on a shelf or on a table, or be a collectible item with intrinsic value apart from the work product it represents. Another tangential element of physically embodied work products is the social interaction associated with trading, swapping, and handling artifacts such as LP covers and CD jewel cases. This activity is no longer possible in a world of exclusively online content. Consumers such as teenagers and young adults enjoy such activity that centers around these artifacts and there is no adequate substitute available in a solely online world.

In summary, the benefits of exclusively online provision of work products such as music and videos are offset by certain disadvantages because such work products are no longer associated with specific tangible embodiments, unlike work products distributed as discs, tapes or other physical media.

### BRIEF DESCRIPTION OF THE DRAWINGS

FIG. 1 is a set of printed embedded tags exemplifying tangible artifacts in one set of embodiments of the invention.

FIG. 2 is a typical arrangement of devices and an activity flow in one embodiment of the invention.

### DETAILED DESCRIPTION

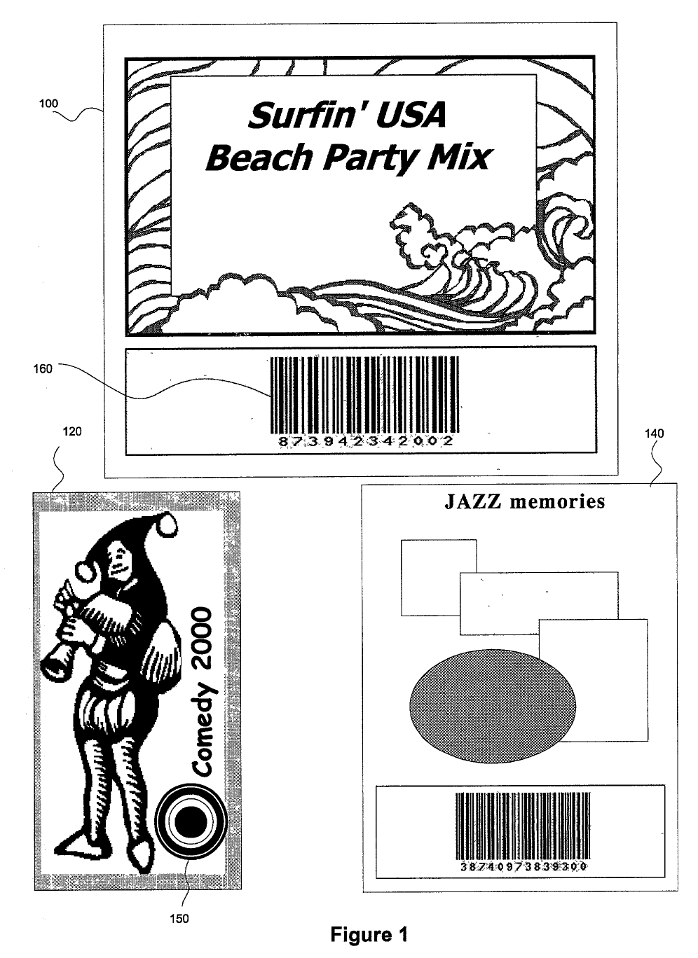

FIG. 1 depicts a set of tangible artifacts that might be produced in association with work products provided as online digital content, in some embodiments of the invention. The artifacts depicted are printed cards produced in an embodiment of the invention wherein a printer and card paper are used to create such cards based on data provided in digital content representing a work product.

In these embodiments of the invention, each work product is represented by one card. The first work product is a set of digitally encoded pop songs in an online collection, entitled “Surfin' USA Beach Party Mix,” associated with the printed card 100. The printed card has on it a graphic logo including the title of the collection and a bar coded digital identifier 160. The graphics, layout and bar code on this card are printed using data that is provided in a special field of the digital format used to encode the songs in the online collection. In this embodiment of the invention, the bar coded digital identifier uniquely identifies this work product, and allows the playback of the online collection when scanned by a suitable device that is connected to a network and an audio reproduction apparatus.

Part of another embodiment of the invention is a printed card 120 that is printed using data embedded as a digital watermark within the digital video portion of an online streaming video work product, a recording of a stand-up comedy show called “Comedy 2000.” A printer attached to a computer with suitable software prints the card depicted after the computer has begun receiving the video from the Internet. The card includes an encoded printed reference 150 that allows the card to be read by a suitable scanning device attached to the same or another computer. In this embodiment of the invention, such a computer equipped with suitable hardware and software automatically directs a web browser to a web site related to the “Comedy 2000” show when the scanning device reads the card.

In yet another embodiment of the invention, a printed card 140 is made available to a consumer of purchased online music content entitled “Jazz Memories” as printable data encoded into a special field of the online work product. When printed on card material using a suitable printer and a computer system with suitable software, this card including the depicted bar code may be used to obtain a discount on a DVD-video disc of the same performance purchased at an online shopping web site, by scanning the card using a suitable reader device attached to the same or another computer system during the online purchase process. In this embodiment of the invention, the same card may alternatively be scanned by a barcode scanner at a video store to obtain the same discount if the consumer chooses to purchase the video in person.

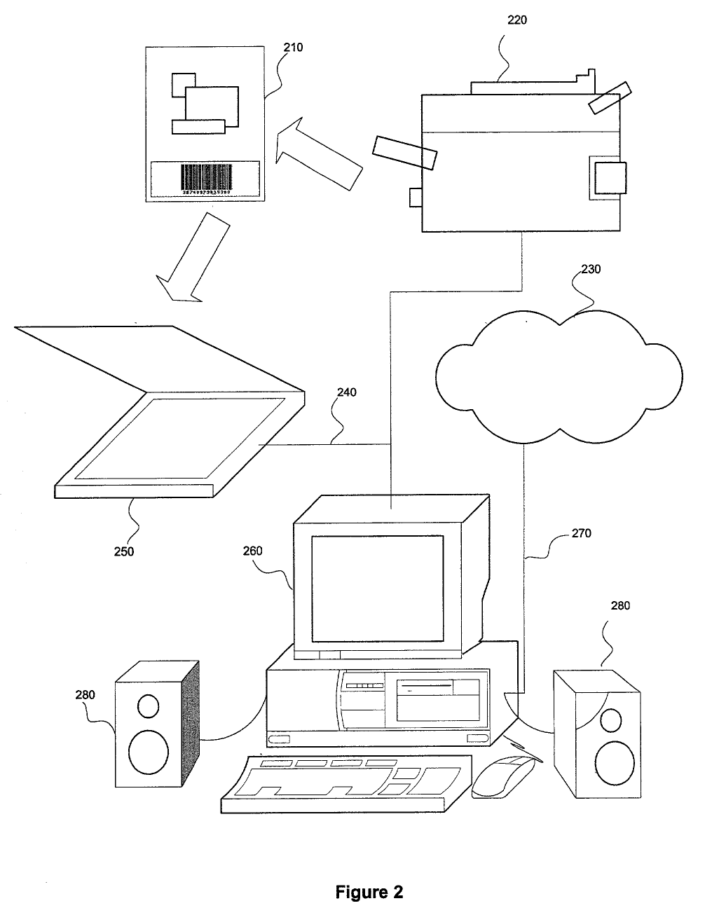

FIG. 2 is a diagram depicting various devices and other entities required to perform one embodiment of the invention. A desktop computer system 260 such as a PC based on an Intel® Pentium® 4 processor, is connected by a bus 240 such as a Universal Serial Bus to peripherals including a scanner 250, loudspeakers 280 and a printer 220. The computer is also connected to the Internet 230 using a network connection 270 that may include a modem such as a cable modem or DSL modem. The computer in this embodiment of the invention is capable of accessing from the Internet a work product distributed as online content, for example, the “Jazz Memories” music performance mentioned with reference to FIG. 1. Concurrently or subsequently the computer may, using application software and a sound card, play the music performance in response to a user's commands. A user accessing the music performance may also, with the aid of suitable software, extract data describing the printed card 210, from a field provided within the digital content distributed as the work product to print the card using appropriate card stock on the printer 220. At another time on the same or on another computer system, the printed card may then be scanned by a reading device such as a scanner 250 with the aid of suitable software in connection with a user using the computer to make an online purchase of a DVD-video disc of the same performance, for example, in order to obtain a discount at the online store. Alternatively, the software reading the printed card may direct the computer to access a related work product such as an online video of the performance directly on the web, or in yet another alternative, retrieve the audio version of the performance once again.

Though only one set of related embodiments of the invention has been presented, the invention as claimed is not limited to these embodiments, and many other embodiments of the invention are possible. In some embodiments of the invention, the tangible artifacts contemplated by the invention are cards that are encoded with embossed raised bumps or alternatively with punched holes as opposed to printed codes, the bumps or holes readable by a suitable reader. A device used to produce such cards may be an embossing device or a cardpunch. These cards may or may not have visible printed matter on their surfaces.

In some embodiments of the invention, the machine-readable reference incorporated into the tangible artifact may be a pattern or a code readable by a magnetic scanner, or alternatively in other embodiments of the invention be a radio-frequency identifier (RFID) to be read by a suitable radio-frequency scanning device. These patterns or codes may be incorporated into the card or other tangible object by printing with special inks or by other means.

In other embodiments, the tangible artifact may be a solid object produced, for example, by a numerically controlled extrusion or molding device. The encoded information may, in these embodiments of the invention, be provided as three-dimensional patterns molded or extruded onto the surface of the solid objects, or as color coding on the surfaces of such objects, or alternatively be any of the other forms of encoding discussed above.

Further, the work product provided as digital content may in some embodiments of the invention be content other than music or a video. The work product could include spoken material such as a lecture, inspirational or religious talk, fiction, an audio drama, or other matter read aloud. The work product may be a multimedia presentation using animation and computer graphics as opposed to video, for example, a presentation similar to a Macromedia Flash™ presentation. The digital content that embodies the work product may in some embodiments be a reference or address on a network, such as a Uniform Resource Locator (URL) or other networked file reference, directing the playing apparatus or software to other digital content by reference.

The computer system as depicted in FIG. 2 is not essential to the invention, rather it represents one embodiment of the invention in which the invention is provided as software that operates with the computer system in accordance with the invention. The invention may be provided as a self contained hardware unit that performs the functions of accessing the digital content, extracting the data that represents the artifact and producing the tangible artifact and/or using such an artifact to access the content or other information related to it. For example the invention may be provided as a unit that incorporates the functions of a printer and scanner into a single integrated unit in conjunction with specific ROM-encoded software. Alternatively, the content accessing function may be performed without a computer by a device similar to an MP3 or other digital content player.

Reference throughout this specification to “one embodiment” or “an embodiment” means that a particular feature, structure or characteristic described in connection with the embodiment of the invention is included in at least one embodiment of the invention. Thus, appearances of the phrases “in one embodiment” or “in an embodiment” in various places throughout this specification are not necessarily all referring to the same embodiment of the invention. Furthermore, the particular features, structures or characteristics may be combined in any suitable manner in one or more embodiments of the invention.

An embodiment of the invention may be performed by hardware components, or may be embodied in machine-executable instructions, which may be used to cause a general-purpose or special-purpose processor or logic circuits programmed with the instructions to perform the invention. Alternatively, the invention may be performed by a combination of hardware and software. The invention may be provided as a computer program product that may include a machine-readable medium having stored thereon data which when accessed by a machine may cause the machine to perform a process according to the invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication link (e.g., a modem or network connection).

Many aspects of the invention are described in their most basic form but can be without departing from the basic scope of the invention. It will be apparent to those skilled in the art that many further modifications and adaptations can be made. The particular embodiments of the invention described above are not provided to limit the invention but to illustrate it. The scope of the invention is not to be determined by the specific examples provided above but only by the claims below.

What is claimed is:

1. A method comprising: associating supplementary data with digital content that embodies a work product, wherein the supplementary data, when accessed by a production device, enables the production device to produce a tangible artifact in accordance with the supplementary data, and the tangible artifact incorporates a machine readable reference that is related to the work product.

2. The method of claim 1, wherein the digital content comprises digital audio data.

3. The method of claim 1, wherein the tangible artifact comprises a printable surface, and the machine readable reference comprises a printed code.

4. The method of claim 2, wherein associating supplementary data with digital content comprises embedding the supplementary data into an audio portion of the digital content.

5. The method of claim 2, wherein associating supplementary data with digital content comprises storing the supplementary data in a non-audio portion of the digital content.

6. A method comprising:
accessing digital content that embodies a work product, accessing supplementary data associated with the digital content, and producing, in accordance with the supplementary data, a tangible artifact that incorporates a machine readable reference that is related to the work product.

7. The method of claim 6, wherein the digital content comprises digital audio data.

8. The method of claim 6 wherein producing the tangible artifact comprises printing the tangible artifact, the tangible artifact comprises a printable surface, and the machine readable reference comprises a printed code.

9. The method of claim 7 wherein the supplementary data associated with the digital content comprises supplementary data embedded into an audio portion of the digital content.

10. The method of claim 7 wherein the supplementary data associated with the digital content comprises supplementary data stored in a non-audio portion of the digital content.

11. An apparatus comprising:
a tangible artifact, produced in accordance with supplementary data associated with digital content that embodies a work product; and
a machine readable reference related to the work product, incorporated into the tangible artifact in accordance with the supplementary data.

12. The apparatus of claim 11 further comprising:
a reader to read the machine readable reference, and to send a signal based thereon; and
a receiver coupled to the reader, to receive the signal therefrom, and to perform an action in response to the signal.

13. The apparatus of claim 11 wherein the digital content comprises digital audio data.

14. The apparatus of claim 11 wherein the tangible artifact comprises a printable surface, and the machine readable reference comprises a printed code.

15. The apparatus of claim 12 wherein the action comprises accessing the digital content that embodies the work product.

16. The apparatus of claim 12 wherein the action comprises accessing auxiliary content related to the work product.

17. The apparatus of claim 13 wherein the supplementary data associated with the digital content comprises supplementary data embedded into an audio portion of the digital content.

18. The apparatus of claim 13 wherein the supplementary data associated with the digital content comprises supplementary data stored in a non-audio portion of the digital content.

19. A machine accessible medium having stored thereon data that when accessed by a machine causes the machine to perform the method of claim 6.

20. The machine accessible medium of claim 19 having stored thereon further data that when accessed by the machine causes the machine to perform the method of claim 7.

21. The machine accessible medium of claim 19 having stored thereon further data that when accessed by the machine causes the machine to perform the method of claim 8.

22. A system comprising:
a tangible artifact, produced in accordance with supplementary data associated with digital content that embodies a work product;
a machine readable reference related to the work product, incorporated into the tangible artifact in accordance with the supplementary data;
a reader to read the machine readable reference, and to send a signal based thereon;
a receiver coupled to the reader, to receive the signal therefrom, and to perform an action in response to the signal; and
a production device to produce the tangible artifact in accordance with the supplementary data.

23. The system of claim 22 wherein:
the tangible artifact comprises a printable surface, and the machine readable reference comprises a printed code;
the reader comprises an optical scanner to scan the printed code;
the receiver comprises a computer system, coupled to the scanner, to decode the printed code read by the scanner and to perform the action in response to the signal; and
the production device comprises the computer system, coupled to a printer, to print the printed code on the printable surface in accordance with the supplementary data.

24. The system of claim 23 wherein:
the digital content comprises digital audio data; and
the action comprises accessing the digital audio data from a network.
